(19) United States
(12) Patent Application Publication
(10) Pub. No.: US 2012/0190759 A1
(43) Pub. Date: Jul. 26, 2012

(54) KEYMAT AND SCREEN STRUCTURE AND METHOD OF ASSEMBLING

(75) Inventors: Chunli Jing, Beijing (CN); Antti Oskari Salo, Lohja (FI)

(73) Assignee: NOKIA CORPORATION, Espoo (FI)

(21) Appl. No.: 12/937,352

(22) PCT Filed: Apr. 10, 2008
(86) PCT No.: PCT/EP2008/002822

§ 371 Date: Nov. 29, 2011

(51) Int. Cl. B01J 41/00; B29C 49/00; B23P 11/00; B29C 45/00

(52) U.S. Cl. 521/25; 264/328.1; 264/500; 29/428

(57) ABSTRACT

A module comprising a keymat and a screen cover. The module is adapted to be used in a device having a screen and at least one key. The module comprises a unitary body comprising said keymat and said screen cover.

### FIELD

The present application relates to a module, a device and a method for easier assembling of devices, and in particular to a module, a device using such a module and a method for assembling a keymat and a screen cover.

### BACKGROUND

Electronic devices, such as mobile phones, music and media players, game consoles, cameras etc are commonly equipped with both a set of keys and a display.

Such devices are often carried in a pocket or handbag where they come in contact with other objects such as coins, keys etc. and in this contact there is a high risk of scratching the device. These devices are also commonly carried around in a wide variety of environments and therefore often subjected to dust, moisture or other contaminants that may damage the device should they be allowed to enter the device. Protecting the device is therefore of importance.

A set of keys or a keypad is commonly implemented with a Printed Wire Board (PWB) having one or more domes on them. These domes are in contact with a keymat, commonly made from rubber, which in turn is connected to physical keys. Sometimes the keymat itself is formed to provide the actual keys. This is the case in for example Nokia 3250™. The contact between the keymat and the dome(s) is provided for by protrusions or plungers on the keymat extending from the keymat to interact with the domes. As a key is pushed, it presses on the keymat which in turn presses on the dome via the plunger and the circuitry detects that the key associated with that dome has been pushed. The keymat serves to protect the inside of the electronic device from moisture, dust and other particles.

To allow the keymat to flex, bend or be temporarily deformed as a key is pushed or pressed so that the pressing action can be propagated to the dome it needs to be flexible and at the same time it needs to provide the user with some tactile feedback so that the user can sense when he has pressed the key to a point where the dome is activated. A rigid keymat would not relay this feeling and would also most likely depress the surrounding domes at the same time.

A display used in portable electronic devices, such as above, is commonly implemented by a Liquid Crystal Display (LCD) screen or similar. To protect the screen against dust, scratches and other physical influences a cover is used. Naturally, to enable a user to see the content of the screen this cover needs to be transparent and preferably scratch resistant.

Some contemporary mobile phones 101 are manufactured in this way having a rubber keymat 102 and a transparent screen cover 103, see FIG. 1. The materials used for the keymat 102 are usually silicon (rubber) and/or Thermoplastic Poly Urethanes (TPU) being both resilient and flexible thus serving well to provide the flexibility and tactility required. The materials used for the screen or display cover 103 are usually poly carbonates or poly methyl methacrylates (PMMAs), commonly referred to as acrylic glass, which are easy to shape and transparent, thus serving well as screen covers 103.

The keymat 102 and screen cover 103 are mounted on top of key domes (not shown) and a screen 104 respectively and below an outer cover, commonly referred to as an A-cover 105 which serves to secure the keymat 102 and the screen cover 103 in place.

In some mobile devices the keymat itself is the keypad and no other physical keys are arranged on top of the keymat. In such a case, the A-cover is sometimes mounted under the keymat and the keymat is arranged with protrusions or plungers that extend through holes in the A-cover to interact with the domes under the A-cover. FIG. 2 shows how a keymat 202 is removed from an A-cover 205 on a Nokia 1101™ and how a new keymat 202 is slid in and pushed down. In FIG. 2A the keymat 202 is pulled away from the A-cover 205 and in FIG. 2B a new keymat 202, perhaps of a different color, is aligned over the A-cover and in FIG. 2C the keymat 202 is pushed in place.

In some devices the screen cover is directly attached to the A-cover by an adhesive or a welding technique. This makes it impossible in practice to exchange the screen cover without replacing the complete A-cover.

For devices having joysticks or multidirectional input keys, the same principle has been used in that each direction of the joystick or multi-directional input key is associated with each a key dome as is commonly known.

Both the screen cover and the keymat need to be secured to the phone to prevent that they fall off partially or fully leaving the phone exposed to contaminants and also difficult to use due to the partially removed user interface. They are secured either to the A-cover or to the underlying structure and this places some constraints on the design and especially for designs with replaceable keymats 102, A-covers 105 and/or screen covers 103. The assembly of such phones is also further complicated by this securing.

The securing can be effected in many ways, some examples are to arrange flanges on the keymat or screen cover that cooperate with slits in the cover or the device, by making the screen cover or keymat larger than the cover which causes the cover to press down upon the screen cover or the keymat and keep them secured when mounted or by arranging a special protrusions or an increased diameter on a portion of some of the plungers so that these cooperate with holes on the device or in the cover. An example of this is shown in FIG. 2A where the plungers 202a communicate with the underlying key domes (not shown) through holes 212 in the A-cover 205.

### SUMMARY

On this background, it would be advantageous to provide a module, a device and a method that overcomes or at least reduces the drawbacks indicated above by providing a module comprising a unitary body comprising a screen cover and a keymat or in other words the keymat and screen cover is made in one integral piece.

By realizing that there has been a problem both in assembling and for protecting the underlying components due to that the screen cover is one part and the keymat is a different part. These problems can be overcome by the use of Thermoplastic Elastomers (TPEs), such as the Living Anionic Polymers LA4285, LA2250 and LA2140 which are both flexible and highly transparent, see Table 1, for making the screen cover and the keymat in one integral piece.

In some prior art solutions the screen cover has to be made using one machine and the keymat using another machine. The two parts will then have to be processed and later mounted on the device one by one. This requires additional machinery and additional steps during the production and/or later assembly.

This also generate constraints that the designer has to meet with regards to protection against dust and other contaminants and to smooth or hidden edges between the screen and the keypad so that neither the screen cover nor the keymat is accidentally ripped off.

Furthermore, due to the high elasticity of TPEs, they can also be used as a seal to prevent dust entering between the display and window. For example, by using a thin arrow shape to form a lip seal. TPEs can also be used to protect the device and especially the display against mechanical impacts, such as drop shock.

The disclosed embodiments provide a module comprising a keymat and a screen cover, which module is adapted to be used in a device comprising a screen and at least one key, wherein said module including said keymat and said screen cover is formed by a single integral portion. The disclosed embodiments also provide a module comprising a keymat and a screen cover, which module is adapted to be used in a device comprising a screen and at least one key, wherein said module comprises a unitary body comprising said keymat and said screen cover.

Such a module can easily be manufactured or processed in one step and later assembled in one step. It has improved capabilities for protecting against dust or other contaminants and it is easy to secure.

It is also cheaper to replace for a user should it become damaged or if the user simply wants to replace it for another reason.

In one embodiment the integral portion or the unitary body is made of a thermoplastic elastomer. Thermoplastic elastomers (TPEs) are true thermoplastics and highly transparent and can therefore meet the criteria for both a screen cover and a keymat. TPEs are commonly known and there are many commercially available alternatives and in this application only a few are listed as examples, but it should be noted that many more are also available for use for a module according to this application.

In one embodiment the thermoplastic elastomer is a Living Anionic Polymer (hereafter referred to as an LA). LAs are commonly known and more information on LAs and their properties can be found in the studies report “Studies of living anionic polymerization of (meth)acrylates in the presence of di-phenoxy alkylaluminum and applications of the block copolymers”, by Kenichi Hamada et al of Kuraray CO LTD and Axel H. E. Milner of University of Bayreuth, Germany, which report is hereby incorporated by reference.

LAs and LA4285, LA2250 and LA2140 in particular are particularly well-suited due to their high transmittance and flexibility. It is also possible to combine the TPEs in any relation, for example 50% LA2250 and 50% LA4285 which is the combination shown in Table 1.

It is also possible combine the TPEs with other plastics should other properties be required or desired.

In one embodiment the integral portion or the unitary body is void of partitioning lines. Partitioning lines make it more difficult to protect against dust and/or other contaminants and they can also make the securing more difficult as the partitioning line requires additional securing measures to be taken. A partitioning line is in this respect assumed to be a partition of two portions.

In one embodiment the module is also adapted to serve as an outer cover for said device. This further decreases the overall size of a device as no additional cover is needed to secure the keymat/screen cover.

It should be noted that the module serving as an outer cover forms part of the device. A full cover such as an enclosing member or sheet has disadvantages in that they increase the overall thickness of a device, make it more difficult to access certain parts of the device, such as for battery replacement, exchanging memory cards or identification modules such as SIM cards (Subscriber Identification Module) Such fully-enclosing or substantially fully-enclosing covers are also prone to breaking or ripping when they are mounted on or removed from a device.

In one embodiment the module serving as an outer cover only partially covers the device.

In one embodiment the transmittance in the screen cover portion is above 90%. And in another above 85% and in still another above 92%. These high transmittances are achieved through the realisation of the possibility of using TPEs as above while still maintaining a high degree of flexibility.

The aspects of the disclosed embodiments are also directed to providing a module comprising a first transparent portion arranged to cover a display and a second flexible portion arranged to cooperate with at least one key dome, wherein said first and second portion are formed of one integral portion.

In one embodiment the integral portion or the unitary body is made of a thermoplastic elastomer, said thermoplastic elastomer being taken from a group comprising LA4285, LA2250 LA2140, and Acrylic TPE LA-polymer or any combination of these.

It is also possible to use any of the Thermoplast® compounds.

In one embodiment the transmittance in the transparent portion is above 90%. And in another above 85% and in still another above 92%. These high transmittances are achieved through the realisation of the possibility of using TPEs as above while still maintaining a high degree of flexibility.

The disclosed embodiments provide a device comprising or incorporating or being adapted to receive a module such as above.

A device adapted to receive a module according to above can easily and quickly be equipped with such a module should the module become damaged, torn or if the user simply wants to replace it.

It also provides for the possibility of selling the device and the module separately.

In one embodiment the device is a portable device adapted to be carried in a pocket.

Such devices have high requirements as to protection against contaminants and scratches and as to that no parts are ripped off or bent while being carried in a pocket or bag

In one embodiment the device is a mobile phone, in yet an embodiment the device is a media player and in one embodiment the device is a personal digital assistant.

In one embodiment the device is a game console. For game consoles different symbols that provide extra information regarding a game could be arranged on the module. This provides for the possibility of selling a customised module with a game.

The aspects of the disclosed embodiments are also directed to providing the use of a thermoplastic elastomer for manufacturing a module according to above.

Using TPEs as above has the benefit of providing a module being both flexible and transparent and TPEs can be processed using traditional techniques such as extrusion, injection and blow moulding.

The aspects of the disclosed embodiments are also directed to providing a method for manufacturing a module comprising a transparent portion and a flexible portion constituting a unitary body or a single integral portion from a thermoplastic elastomer using one of or a combination of extrusion, injection and blow moulding.

The aspects of the disclosed embodiments are also directed to providing a method for assembling a mobile device comprising attaching a module according to above on top of a screen and at least one key dome.

By manufacturing only one integral piece or a unitary body instead of two separate pieces the assembly is simplified and the machinery necessary is reduced as only one machine instead of two is necessary. The overall cost of manufacturing and assembling a device incorporating such a module is thereby reduced.

In one embodiment a cover portion is mounted over the module. By mounting a cover over the module it is better secured and protected against being torn off from a device.

In one embodiment the module is mounted over a cover portion. By mounting the module over the cover portion it is easier to replace the module and it will also serve to protect the cover should it for example have some sensitive components such as Light Emitting Diodes (LED) or such. It also serves to provide a smooth and appealing surface.

Further objects, features, advantages and properties of device, method and computer readable medium according to the present application will become apparent from the detailed description.

### BRIEF DESCRIPTION OF THE DRAWINGS

In the following detailed portion of the present description, the teachings of the present application will be explained in more detail with reference to the example embodiments shown in the drawings, in which:

FIG. 1 is an overview of a device its various parts,

FIG. 2 is a series of views of a prior art embodiment,

FIG. 3 is a block diagram illustrating the general architecture of a device of FIG. 1,

FIGS. 4 A, B, C and D are schematic views of a device and its parts according to an embodiment, and

FIG. 5 is a series of views of an embodiment according to this application.

### DETAILED DESCRIPTION

In the following detailed description, the module, the device, the production method and the assembly method according to the teachings of this application in the form of a cellular/mobile phone will be described by the embodiments. It should be noted that although only a mobile phone is described the teachings of this application can also be used in any electronic device such as in portable electronic devices such as Personal Digital Assistants (PDAs), mobile communication terminals, electronic books, game consoles, media players and notepads and other electronic devices offering access to information.

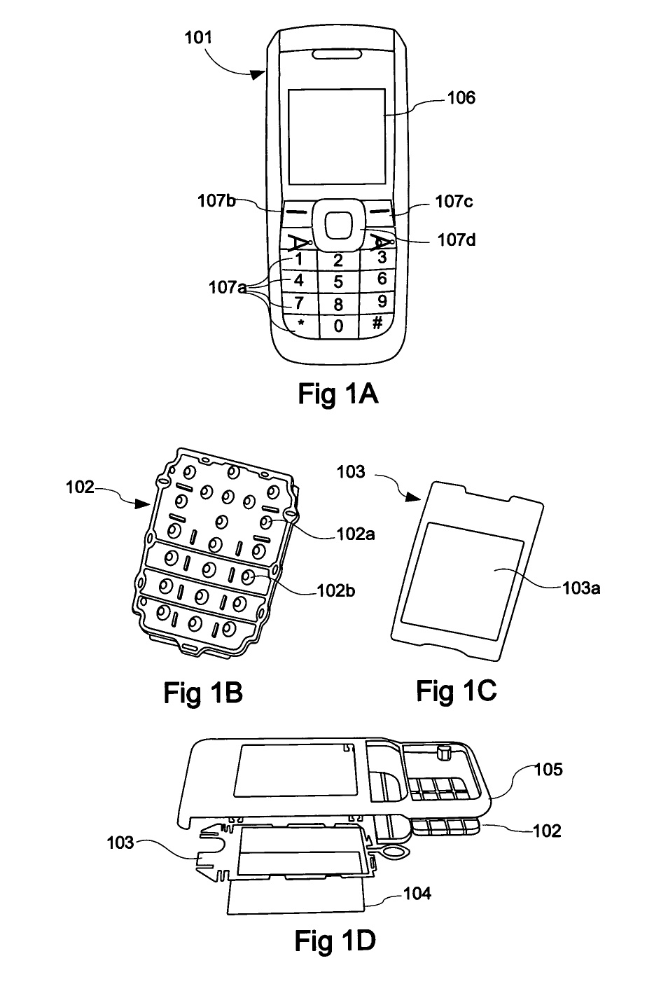

FIG. 1A illustrates an example of a prior art mobile terminal 101. The mobile terminal 101 comprises a main or first display 104 and a set of keys 107 which may include a keypad 107a of common ITU-T type (alpha-numerical keypad representing characters “0”-“9”, “*” and “#”) and certain other keys such as soft keys 107b, 107c and a joystick or other type of navigational input device such as a five-way key 107d. These features are common to both prior art solutions and solutions according to the teachings herein.

FIG. 1B shows a prior art keymat 102 having plungers 102a and a keymat base 102b. FIG. 1C shows a prior art screen cover 103 having a transparent area 103a.

FIG. 1D shows a prior art exploded view of a mobile phone 101 having an A-cover 105, a screen 104, a screen cover 103 and also a keymat 102 forming a keypad 107 by extending from the A-cover 105. The A-cover 105 secures the keymat 102 to a device (not shown) by having a rim that extends over an edge of the keymat 102 and which applies pressure to the keymat 102 as the keymat and the A-cover 105 is mounted on or assembled in a device.

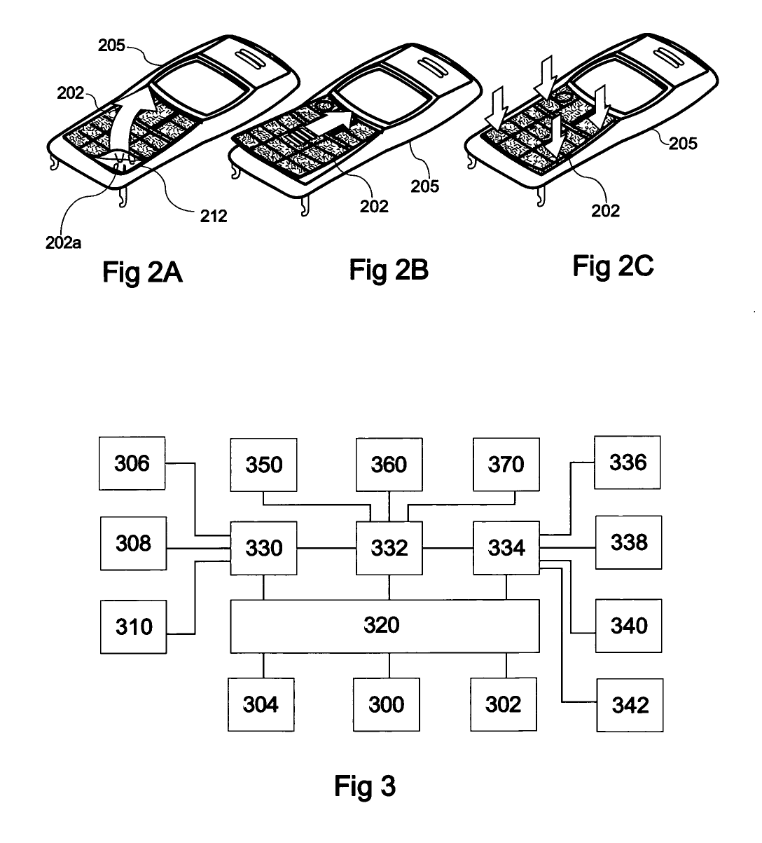

FIG. 2 shows how a prior art keymat could be replaced from an A-cover by ripping off the old one and then sliding in a new one.

The internal component, software and protocol structure of a mobile terminal 101 will now be described with reference to FIG. 3. The mobile terminal 101 has a controller 300 which is responsible for the overall operation of the mobile terminal and may be implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a message text editor 350, a notepad application 360, as well as various other applications 370, such as applications for voice calling, video calling, sending and receiving Short Message Service (SMS) messages, Multimedia Message Service (MMS) messages or email, web browsing, an instant messaging application, a phone book application, a calendar application, a control panel application, a camera application, one or more video games, a notepad application, etc. It should be noted that two or more of the applications listed above may be executed as the same application

The MMI 334 also includes one or more hardware controllers, which together with the MMI drivers cooperate with the first display 336/104, and the keypad 338/107 as well as various other I/O devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, band pass filters, amplifiers, mixers, local oscillators, low pass filters, AD/DA converters, etc.

The mobile terminal also has a SIM (Subscriber Identity Module) card 304 and an associated reader. As is commonly known, the SIM card 304 comprises a processor as well as local work and data memory.

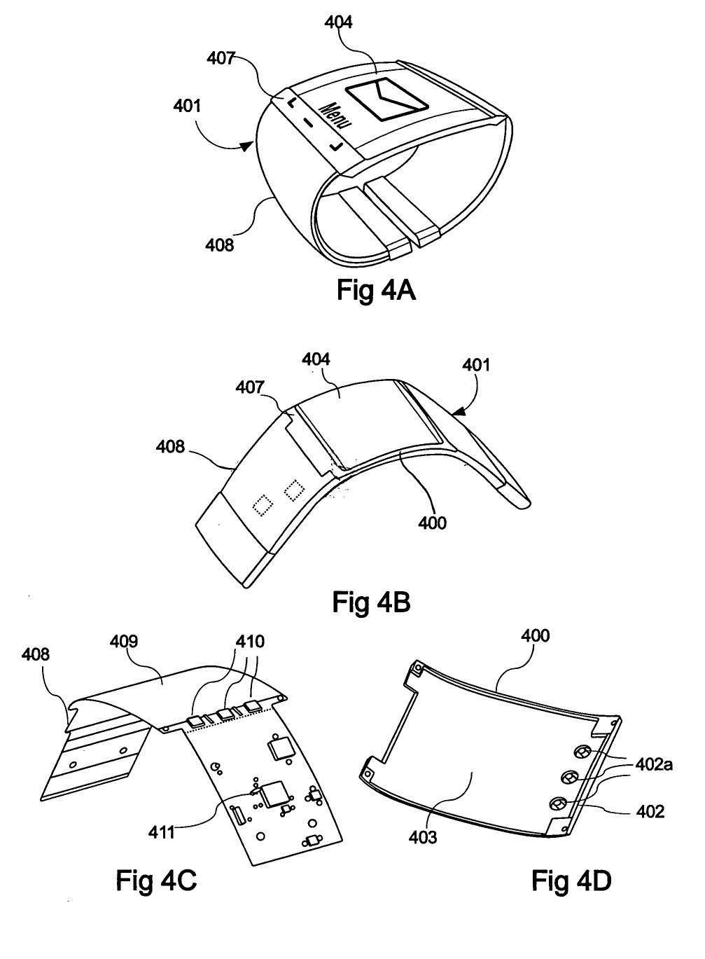

FIG. 4A shows a mobile device according to the teachings herein. The mobile device is a wrist mounted mobile phone 401 having a display 404 and a keypad 407 mounted on a body portion 408, in this example the actual wrist mount. It should be noted that the teachings herein can also be used in other mobile devices such as fold phones, swivel phones, mono-block phones and such.

In FIG. 4B a schematic drawing of such a mobile phone 401 is shown having the same display 404, keypad 407 and body 408.

FIG. 4C shows a detailed schematic view of the body portion 408 on which various circuits 411 are mounted. These circuits may be the circuits as has been described with reference to FIG. 3 above. Key domes 410 are also mounted on the body portion 408 and these are connected to the circuits 411 through the MMI 338 (not shown in FIG. 4). The body portion also has a space 409 where a display 404 is to be arranged.

A module consisting of one integral part 400 is shown in FIG. 4C. This module 400 serves as both a screen cover 403 and a keymat 402.

By using a Thermoplastic elastomer (TPE), in particular Living Anionic Polymers, LAs, such as LA4285, LA2250 or LA2140 which have the properties of both being highly transparent and highly flexible, one integral part 400 can be molded and later assembled at once to serve both as a keymat 402 and a screen cover 403. The assembly is also simplified by this realization as only one part instead of two has to be assembled. Furthermore it is much easier to secure one part than two secure two separate parts especially as no partitioning line exists. These partitioning lines are very susceptible to introduce dust and other contaminants and also for snagging or catching an adjacent part on protrusions existing in the environment thus causing increased wear and tear and also potential damage to the device.

Tests have shown that TPEs such as these have a transmittance of above 90% over the visible spectra (400 to 800 nm) for a film being 400 μm thick and as they can also be stretched repeatedly without causing permanent deformation they fulfill both the criteria for a keymat and for a screen cover and by realizing this and utilizing the fact that these TPEs can also processed by the conventional techniques of injection, extrusion and blow molding modules 400 such as above can easily be manufactured end employed.

Table 1 shows some of the properties making TPEs and LAs in particular highly suitable for use in manufacturing one-piece keymat and screen covers.

The module 400 is arranged over a screen 404 and the key domes 411 so that the screen cover area 403 is arranged over the screen 404 and the plungers 402a are arranged over the key domes 411.

In prior art solutions a partitioning line exists between the screen 404 and the keypad 407 which has to be hidden or protected with a cover, such as an A-cover, making assembly more difficult and increasing size, weight and outer dimensions of the device. As the screen cover and keymat in a module and device according to the teachings herein consist of the same integral piece or portion such a partitioning line does not exist and these factors above can thus be kept lower. As is clear to a skilled person these are all factors that are important to keep as low as possible to make the device attractive to users, both from an aesthetic point of view and from a practical point of view.

The assembly of a phone or other device is also simplified in that one instead of two pieces needs to be manufactured and assembled. This also leads to reduced costs.

The freedom for designers is increased as the constraints put on the design to secure both a free screen cover and a free keymat is removed and as it is generally easier to secure one part than two, especially if they are adjacent to each other is much more difficult, and this renders the device more intact and protected against dust and other impurities. Using a module such as described above will thus enable designers to make designs that were previously thought not possible in practice.

It will also be easier to update or change the appearance of a device as both the screen cover and the keymat can now be exchanged using, for example, the technique shown in FIG. 4. It should be understood that other techniques for replacing and for securing the module are also possible. This will allow users to change the screen covers more often and at a lower price.

If the module 400 is used as the outer cover for the device it will be easier and cheaper for a user to keep his device looking fresh and being intact as the module is easy to exchange as it gets worn or damaged and is much cheaper than the traditionally used A-covers.

It should be noted that it is also possible to mount the module 400 on the body directly without using an A-cover in which case the module itself serves as the A-cover. Such is the case in FIG. 4 where the module 400 is mounted or assembled directly on the body portion 408.

It should also be noted that the keymat portion may be formed so as to provide the physical keys that the user will be pushing directly. This is the case in FIG. 4A.

A device, such as a mobile phone, can easily be adapted to receive a module such as described herein by being arranged with securing means adapted to cooperate with securing means on the module. These securing means may be flanges and slits, protrusions and holes, adhesives, cooperating dimensions or other techniques for securing one body to another depending on the requirements posed on the securing.

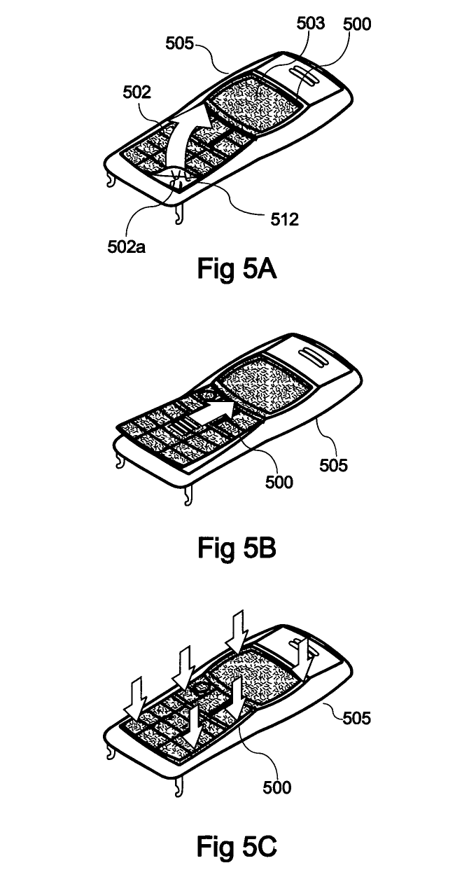

FIG. 5 shows how a module 500 including a keymat 502 and a screen cover 503 is removed from an A-cover 505 and how a new module 500 is slid in and pushed down. In FIG. 2A the module 500 is pulled away from the A-cover 505 and in FIG. 2B a new module 500, perhaps of a different color or with different markings, is aligned over the A-cover 505 and in FIG. 2C the module 500 is pushed in place. FIG. 5A shows the securing means in the form of plungers 502a and receiving holes 512. The plungers 502a have a portion with an increased diameter so that as they have been pushed through the receiving holes 512 they are movably secured.

The various aspects of what is described above can be used alone or in various combinations. It should be noted that the teaching of this application is not limited to the use in mobile communication terminals such as mobile phones, but can be equally well applied in Personal Digital Assistants (PDAs), game consoles, MP3 players, personal organizers, electronic books, cameras or any other device designed for having a screen and a keypad.

The teaching of the present application has numerous advantages. Different embodiments or implementations may yield one or more of the following advantages. It should be noted that this is not an exhaustive list and there may be other advantages which are not described herein. One advantage of the teaching of this application is that a device Can be made smaller and to a lower cost in that the number of components and the complexity of their design is reduced.

Another advantage of the teaching of the present application is that the assembly of a device incorporating such a module also becomes easier and cheaper in that one part less I used.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the teachings of the present application may also be applied to other types of electronic devices, such as music players, palmtop computers and the like. It should also be noted that there are many alternative ways of implementing the methods and apparatuses of the teachings of the present application.

The term “comprising” as used in the claims does not exclude other elements or steps. The term “a” or “an” as used in the claims does not exclude a plurality. A unit or other means may fulfill the functions of several units or means recited in the claims.

TABLE 1

| | | Test | | | LA2250/ | |
|---|---|---|---|---|---|---|
| Property | Unit | method | LA2140e | LA2250 | LA4285 | LA4285 |
| Hardness | (—) | JIS K | 32 | 65 | 87 | 95 |
| [Type A] | | 6253 | | | | |
| Specific | (—) | JIS K | 1.08 | 1.0 | 1.10 | 1.11 |
| Gravity | | 7112 | | | | |
| Modulus | (MPa) | JIS K | 0.3 | 3.7 | 19.1 | 19.1 |
| at 100% | | 6251 | | | | |
| Tensile | (MPa) | JIS K | 8 | 9 | 12 | 19 |
| Strength | | 6251 | | | | |
| Tensile | (%) | JIS K | 570 | 380 | 190 | 120 |
| elongation | | 6251 | | | | |
| MFR | (g/ | JIS K | 31 | 25 | 5 | 1.5 |
| [190° C., | 10 min) | 7210 | | | | |
| 2.16 Kg] | | | | | | |
| MFR | (g/ | JIS K | Off the | 330 | 93 | 31 |
| [230° C., | 10 min) | 7210 | scale | | | |
| 2.16 Kg] | | | | | | |
| Transmit- | (%) | JIS K | 91 | 91 | 91 | 91 |
| tance | | 7361-1 | | | | |
| (3mmt) | | | | | | |
| Haze | (%) | JIS K | — | 2 | 2 | 2 |
| (3mmt) | | 7136 | | | | |

1.-17. (canceled)

18. A module comprising a keymat and a screen cover, said module is configured to be used in a device comprising a screen and at least one key, wherein said module comprises a unitary body comprising said keymat and said screen cover.

19. A module according to claim 18, wherein said unitary body comprises thermoplastic elastomer.

20. A module according to claim 19, wherein said thermoplastic elastomer comprises Living Anionic Polymer.

21. A module according to claim 19, wherein said thermoplastic elastomer comprises one of LA4285, LA2250 and LA2140.

22. A module according to claim 18, wherein said unitary body is void of partitioning lines.

23. A module according to claim 18, wherein said module is configured to serve as an outer cover for said device.

24. A module comprising a first transparent portion configured to cover a display and a second flexible portion configured to cooperate with at least one key dome, wherein said first and second portion are formed of one integral portion.

25. A module according to claim 24, wherein said unitary body is made of a thermoplastic elastomer, said thermoplastic elastomer is made one of LA4285, LA2250 and LA2140.

26. A device configured to receive a module according to claim 18.

27. A device according to claim 26, wherein said device comprises at least one of a media player, a game console, a personal digital assistant, an electronic book, a camera, a video camera and a mobile phone.

28. A device according to claim 26, wherein said device is a portable device.

29. A device according to claim 28, wherein said device comprises at least one of a media player, a game console, a personal digital assistant, an electronic book, a camera, a video camera and a mobile phone.

30. A method for assembling a mobile device comprising attaching a module according to claim 1 on top of a screen and at least one key dome.

31. A method according to claim 30, comprising a cover portion is configured to be mounted over the module.

32. A method according to claim 30, wherein the module is configured to be mounted over a cover portion.

33. A method for assembling a module according to claim 18, comprising a transparent portion and a flexible portion comprising the unitary body made from a thermoplastic elastomer using at least one of the following extrusion, injection and blow moulding.
